(19) United States
(12) Patent Application Publication
(10) Pub. No.: US 2001/0033063 A1
(43) Pub. Date: Oct. 25, 2001

(54) Vehicle-trailer concept

(76) Inventor: Mark W. Wood, Jackson, TN (US)

Correspondence Address: Mark W. Wood, 3795 Beech Bluff Rd., Jackson, TN, 38301, US

(21) Appl. No.: 09/790,225

(22) Filed: Feb. 21, 2001

Related U.S. Application Data
(60) Provisional application No. 60/197,647, filed on Apr. 17, 2000.

(51) Int. Cl. B62D 61/12

(52) U.S. Cl. 280/43; 280/80.1; 180/209; 280/86.5

(57) ABSTRACT

A towing vehicle and towed attached trailer connected using a ridged non-pivoting connection. The connection can be released by the user as desired to use the towing vehicle as a separate independent vehicle and reconnected as needed for towing of the trailer. The driving wheels of the towing vehicle are the front wheels. After the trailer is connected to the towing vehicle, the rear wheels of the towing vehicle are retracted vertically off of the ground shifting the combined weight of the vehicle and trailer to the front wheels of the vehicle and to the trailer wheels.

### FIELD OF THE INVENTION

This invention generally relates to motorized vehicles and attached trailers for towing behind motorized vehicles.

Existing motorized vehicles are designed to be operated independently or as a towing vehicle with one or two attached towed trailers connected in tandem. The connecting points are generally pivoting joints allowing substantial freedom of rotation in the pitch, roll and yaw axes between the towing vehicle and the towed trailer or trailers.

The pitch and roll pivoting freedom allows the vehicle and trailers to independently conform to uneven terrain while connected. The yaw pivoting freedom allows unconstrained turning to enhance maneuverability.

One significant disadvantage of yaw pivoting freedom is vehicle and trailer instability at highway traveling speeds. Several methods are presently employed to control yaw instability including energy absorbing dampers to reduce yaw pivoting rates, multiple axle trailers and proper distribution of the load on the trailer.

A second disadvantage of yaw pivoting freedom is increased control difficulty in backing up the vehicle and trailer. With two towed trailers, the control difficulty in backing is even greater and is normally only attempted by professionally trained drivers.

### SUMMARY OF THE INVENTION

To avoid the limitations and problems of existing motorized vehicles and attached trailers, the object of this invention is to create a ridged non-pivoting connection between the towing vehicle and the connected trailer. The connection can be released by the user as desired to use the towing vehicle as a separate independent vehicle and reconnected as needed for towing of the trailer.

The front wheels of the towing vehicle are steerable and are the driving wheels. After the trailer is connected to the towing vehicle, the rear wheels of the towing vehicle are retracted vertically off of the ground shifting the combined weight of the vehicle and trailer to the front wheels of the vehicle and to the trailer wheels.

An alternative to fully retracting the rear vehicle wheels after the trailer is connected to the towing vehicle, is to substantially reduce the load bearing weight on the rear wheels of the towing vehicle without vertically retracting them, shifting the most of the combined weight of the vehicle and trailer to the front wheels of the vehicle and to the trailer wheels.

In another alternative embodiment of this invention, the rear wheels of the towing vehicle are steerable and are the driving wheels and the front wheels are also steerable. After the trailer is connected to the towing vehicle, the front wheels of the towing vehicle are retracted vertically off of the ground shifting the combined weight of the vehicle and trailer to the rear wheels of the vehicle and to the trailer wheels.

In yet another alternative embodiment of this invention, both the front and rear wheels of the towing vehicle are steerable and are the driving wheels. After the trailer is connected to the towing vehicle, the combined weight of the vehicle and trailer is supported by the front and rear wheels of the towing vehicle and the trailer wheels. Steering is accomplished by coordinated steering of both the front and rear wheels of the towing vehicle.

The advantages of this vehicle & trailer concept are that the driving characteristics of the connected vehicle and trailer are substantially similar to that of a conventional two axle vehicle. Vehicle stability at highway speeds is substantially improved, backing up of the connected vehicle and trailer is also easier. Another advantage of this concept is that in the connected mode, vehicle weight on the front driving wheels are increased for greater traction and steering control. An additional advantage is that a second trailer can be attached to the rear of the first trailer using a conventional pivoting trailer connection resulting in a dual trailer payload capacity while retaining the handling characteristics of a conventional single trailer and vehicle.

### BRIEF DESCRIPTION OF THE DRAWINGS

FIG. 1 is a side elevation view of the new concept vehicle 1, showing front axle 3 and rear axle 4, and of new concept trailer 2 showing trailer axle 5 and front support 8, with vehicle 1 and trailer 2 not connected. For ease of explanation, rear trailer axle 5 is shown as a single axle about which yaw pivoting of trailer 2 occurs, however the single axle may be replaced with multiple axles dosely spaced to facilitate yaw pivoting while increasing trailer load capacity without deviating from the scope of this patent.

FIG. 2 is a side elevation view of the new concept vehicle 1 and new concept trailer 2 rigidly connected showing front vehicle axle 3 and trailer axle 5 supporting the combined vehicle and trailer weight and showing front trailer support 8 retracted and hidden from view and rear vehicle axle 4 retracted vertically off of the ground.

FIG. 3 is a side elevation view of the new concept vehicle 1 and new concept trailer 2 rigidly connected as shown in FIG. 2 and showing a conventional trailer 6 connected to rear of trailer 2 using a conventional pivoting connection 7.

While trailer 2 is shown as a family camping vehicle and vehicle 1 is shown as a pickup truck in the drawings, trailer 2 can also be an animal transport trailer, a car hauling trailer, flat bed utility trailer or any other type of recreation, utility or commercial trailer without deviating from the scope of this patent. In addition, the vehicle may also be a van, a sport utility vehicle or any other type of family or commercial vehicle which can be designed with front driving wheels, retractable rear wheels and a matching rigid trailer attachment means without deviating from the scope of this patent.

### DESCRIPTION OF THE PREFERRED EMBODIMENT

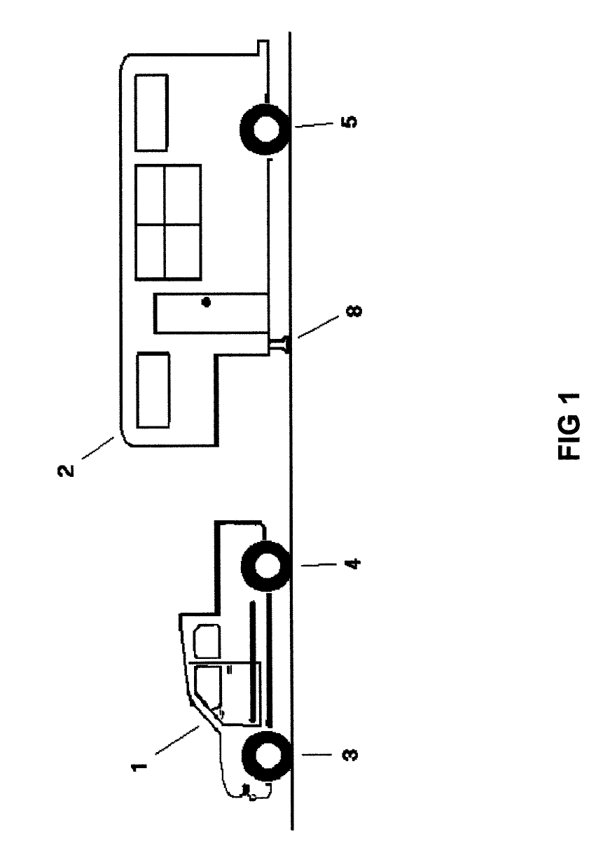

Referring now to FIG. 1 of the drawings, vehicle 1 and trailer 2 are shown disconnected from each other. While disconnected, vehicle 1 can be used independent of trailer 2 as a conventional two axle vehicle with front driving axle 3 and rear axle 4 supporting the weight of the vehicle. Trailer 2, while disconnected is immobile and supported by rear axle 5 and front support 8.

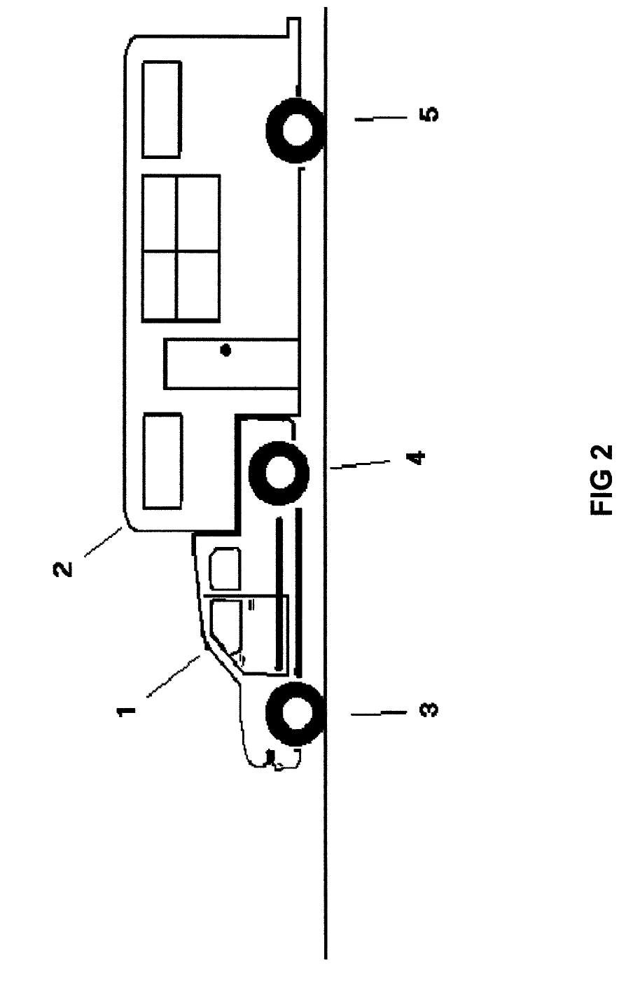

FIG. 2 of the drawings shows vehicle 1 and trailer 2 connected to each other. Front trailer support 8 is retracted and hidden from view while rear vehicle axle 4 is retracted vertically off of the ground. The connecting means consists of several rigid attaching points along the interface between the trailer and vehicle. The attaching points are located at high strength points on both the trailer and vehicle to maximize the rigidity of the connecting means. In the connecting process, means are provided to retract the front trailer support 8 and to retract the rear vehicle axle 4.

Once the connection is completed, the vehicle and attached trailer can be driven to a destination. Since the connection is rigid, an interior passage way can be provided between the trailer and the vehicle to allow communication and passage between the vehicle and trailer during connection and highway traveling.

At the destination, the trailer can be disconnected and secured in a fixed location while the vehicle can be used to provide convenient local transportation.

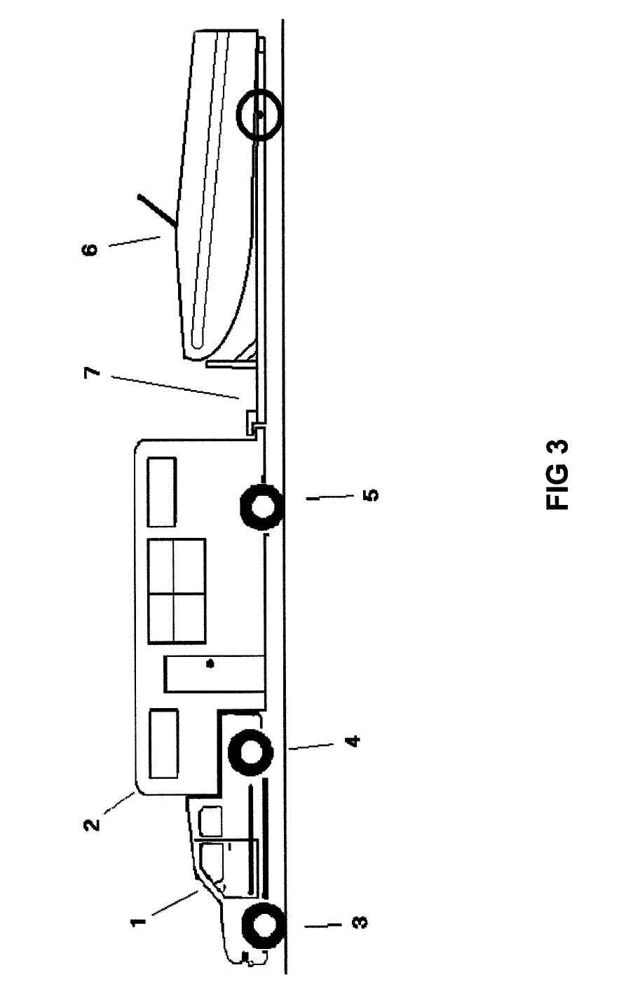

Should the need arise to haul two trailers to a destination, such as a camping trailer and a boat on a boat trailer as shown in FIG. 3, the increased stability and ease of handling of the new concept vehicle 1 and trailer 2 when rigidly connected will permit the second trailer 6 to be connected to the rear of trailer 2 using a conventional pivoting connection. The driving and steering characteristics of the vehicle and two trailer combination will be similar to that of a conventional vehicle and single trailer with pivoting connection and require only a normal non-commercial driving skill level.

1. A motorized towing vehicle and attached trailer, with attaching means for maintaining a ridged non-pivoting connection between said towing vehicle and said connected trailer.

2. The towing vehicle and trailer of claim 1, wherein said attaching means can be released by the user as desired to use said towing vehicle as a separate independent vehicle and reconnected as needed for towing of said trailer.

3. The towing vehicle and trailer of claim 2, wherein the front wheels of said towing vehicle are steerable and are driving wheels.

4. The towing vehicle and trailer of claim 3, wherein the rear wheels of said towing vehicle are retracted vertically off of the ground after said trailer is connected to said towing vehicle.

5. The towing vehicle and trailer of claim 3, wherein the vertical load placed on the rear wheels of said towing vehicle is substantially reduced after said trailer is connected to said towing vehicle.

6. The towing vehicle and trailer of claim 2, wherein the rear wheels of said towing vehicle are steerable and are driving wheels and the front wheels are also steerable.

7. The towing vehicle and trailer of claim 6, wherein said front wheels of said towing vehicle are retracted vertically off of the ground after said trailer is connected to said towing vehicle.

8. The towing vehicle and trailer of claim 2, wherein the front and rear wheels of said towing vehicle are both steerable and are driving wheels.

9. The towing vehicle and trailer of claim 8, wherein the combined weight of said vehicle and trailer is supported by said front and rear wheels of said towing vehicle and the trailer wheels.

10. The towing vehicle and trailer of claim 9, wherein steering is accomplished by coordinated steering of both said front and rear wheels of said towing vehicle.
